(19) United States
(12) Patent Application Publication
(10) Pub. No.: US 2012/0155066 A1
(43) Pub. Date: Jun. 21, 2012

(54) MEMORIAL LIGHTING

(75) Inventors: Bradley M. Carlson, Whitmore Lake, MI (US); Jason T. Grant, Holland, MI (US); Daniel G. Parker, Grand Rapids, MI (US); Benjamin L. Pierce, Rives Junction, MI (US)

(73) Assignee: UBERMEMORIALS, INC., Whitmore Lake, MI (US)

(21) Appl. No.: 13/331,517

(22) Filed: Dec. 20, 2011

Related U.S. Application Data
(60) Provisional application No. 61/424,931, filed on Dec. 20, 2010.
(60) Provisional application No. 61/543,592, filed on Oct. 5, 2011.

(51) Int. Cl. F21S 8/02; F21S 8/00

(52) U.S. Cl. 362/145

(57) ABSTRACT

Embodiments of a lighted memorial are provided. In one embodiment, the lighted memorial may include one or more light sources for illuminating information regarding a deceased, for example, a name, date of birth and date of death. The information regarding the deceased may be placed on a monument, and the light sources may be mounted in, on or adjacent to a base to illuminate the information on the monument. In another embodiment, the information regarding the deceased may be formed in a lens positioned above the light source so that the light source may provide back lighting for the lens. In another embodiment, the light source and lens may be positioned above a housing for containing the cremated remains of a deceased. The remains housing, light source and lens may be mounted at least partially within a base.

### BACKGROUND OF THE INVENTION

The present invention relates to memorials, and more particularly to memorials for deceased persons or pets.

Memorials are generally positioned at the location where a deceased is buried, or on the container holding the cremated remains of a deceased. The memorial will often include the name of the deceased, the date of birth and the date of death. Loved ones often visit the memorial on holidays, birthdays, or other special anniversaries in the life of the deceased. Loved ones may also take care to make sure the memorial is visually pleasing by keeping the memorial clean and placing flowers and other decorations on the memorial. Additionally, the memorial itself may include various visually pleasing designs and features.

Although there are many existing methods for adorning memorials, there exists room for improvement.

### SUMMARY OF THE INVENTION

The present invention provides a lighted memorial that includes a light source for illuminating a portion of the memorial.

In one embodiment, the lighted memorial includes a monument portion, a base portion and at least one light source for illuminating at least a portion of the monument portion. One or more light sources may be positioned within one or more recesses defined in the base portion and/or the monument portion. The recesses may also receive wiring for connecting between the light source and a power source. The light source may have a variety of configurations, including a cylinder, a divided cylinder with a first part oriented at an angle to a second part, a light bar, and a sconce. This embodiment may be powered using any suitable power source, including hard wiring, power storage devices and solar panels.

In another embodiment, the lighted memorial includes a housing, a lens and a light source positioned below the lens and illuminating at least a portion of the lens. A solar panel may be positioned below the lens and connected to a power storage device to power the light source. The light source may be secured to a surface positioned at an angle relative to the lens, with the angle selected to achieve desired lighting characteristics. This embodiment may include any of a variety of securing mechanisms, including a snap fastener and an anchor assembly.

In yet another embodiment, the lighted memorial includes a base portion adapted to receive the cremated remains of a deceased, a lens secured relative to the base portion and a light source adjacent the lens and illuminating at least a portion of the lens. This embodiment may include a housing positioned within a recess defined in the base portion. The housing may include a light housing supporting the light source and a remains housing for containing the cremated remains. This embodiment may include more than one light source positioned in a variety of configurations. For example, two light sources may be positioned on opposite sides of the lens and may generally face or be directed towards one another.

The lighted memorial of the present embodiments may provide a unique and enhanced adornment for memorials. The lighted memorial may also allow for easier viewing of the memorial at times when there is little or no sunlight.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front perspective view of one embodiment of the present invention.

FIG. 2 is a front perspective view of a light associated with the embodiment of FIG. 1.

FIG. 3 is a front perspective view of an installation step associated with the embodiment of FIG. 1.

FIG. 4 is a front perspective view of an installation step associated with the embodiment of FIG. 1.

FIG. 5 is a front perspective view of an installation step associated with the embodiment of FIG. 1.

FIG. 6 is a front perspective view of an installation step associated with the embodiment of FIG. 1.

FIG. 7 is a side view of a light associated with another embodiment of the present invention.

FIG. 8 is a front perspective view of another embodiment of the present invention.

FIG. 9 is a front view of a light associated with the embodiment of FIG. 8.

FIG. 10 is a front perspective view of an installation step associated with the embodiment of FIG. 8.

FIG. 11 is a front perspective view of another embodiment of the present invention.

FIG. 12 is a lower perspective view of a light associated with the embodiment of FIG. 11.

FIG. 13 is a front perspective view of an installation step associated with the embodiment of FIG. 11.

FIG. 14 is a front perspective view of an installation step associated with the embodiment of FIG. 11.

FIG. 15 is a front perspective view of an installation step associated with the embodiment of FIG. 11.

FIG. 16 is a front perspective view of an installation step associated with the embodiment of FIG. 11.

FIG. 17 is a front perspective view of an installation step associated with the embodiment of FIG. 11.

FIG. 18 is a front perspective view of another embodiment of the present invention.

FIG. 19 is a front perspective view of another embodiment of the present invention.

FIG. 20 is a front perspective view of another embodiment of the present invention.

FIG. 21 is a front perspective view of another embodiment of the present invention.

FIG. 22 is a perspective view of a powering configuration associated with the embodiments of the present invention.

FIG. 23 is a perspective view of another powering configuration associated with the embodiments of the invention.

FIG. 24 is a perspective view of another powering configuration associated with the embodiments of the invention.

FIG. 25 is a front perspective view of another embodiment of the present invention in a base mounting location.

FIG. 26 is a front perspective view of the embodiment of FIG. 25 in a ground mounting location.

FIG. 27 is a front perspective view of the embodiment of FIG. 25 in a ground mounting location.

FIG. 28 is a front perspective view of the embodiment of FIG. 25 in a base mounting location.

FIG. 29 is a front perspective view of the embodiment of FIG. 25.

FIG. 30 is a front perspective view of the embodiment of FIG. 25.

FIG. 31 is a front perspective view of the embodiment of FIG. 25 with the cover removed.

FIG. 32 is a side view of the embodiment of FIG. 25.

FIG. 33 is a sectional view along the line 33-33 in FIG. 32.

FIG. 34 is a side view of the embodiment of FIG. 25.

FIG. 35 is a sectional view of a mounting configuration associated with the embodiment of FIG. 25.

FIG. 36 is a front perspective view of another embodiment of the present invention.

FIG. 37 is a front perspective view of another embodiment of the present invention.

FIG. 38 is a top view of the embodiment of FIG. 37 with the base portion removed.

FIG. 39 is a front perspective view of another embodiment of the present invention.

FIG. 40 is a top view of the embodiment of FIG. 39 with the base portion removed.

FIG. 41 is a side view of a housing associated with the embodiments of FIGS. 37 and 39.

FIG. 42 is a front perspective view of another embodiment of the present invention.

FIG. 43 is a schematic of a circuit associated with the embodiments of the present invention.

FIG. 44 is an illustration of a battery associated with the embodiments of the present invention.

FIG. 45 is a bottom view of a circuit board associated with the embodiments of the present invention.

FIG. 46 is a bottom view of a circuit board associated with the embodiments of the present invention.

FIG. 47 is an illustration of a battery associated with the embodiments of the present invention.

FIG. 48 is a flow chart associated with the embodiments of the present invention.

### DETAILED DESCRIPTION OF THE CURRENT EMBODIMENTS

### I. Overview

Several embodiments of a lighted memorial are provided. The embodiments generally include a memorial, monument or headstone with an associated light source mounted in, on or adjacent the memorial. The light source may be powered by a variety of methods, including hard wiring, battery power and solar power. The lighted memorial may be placed in any suitable location, including a cemetery, memorial garden, and the like.

### II. First Embodiment

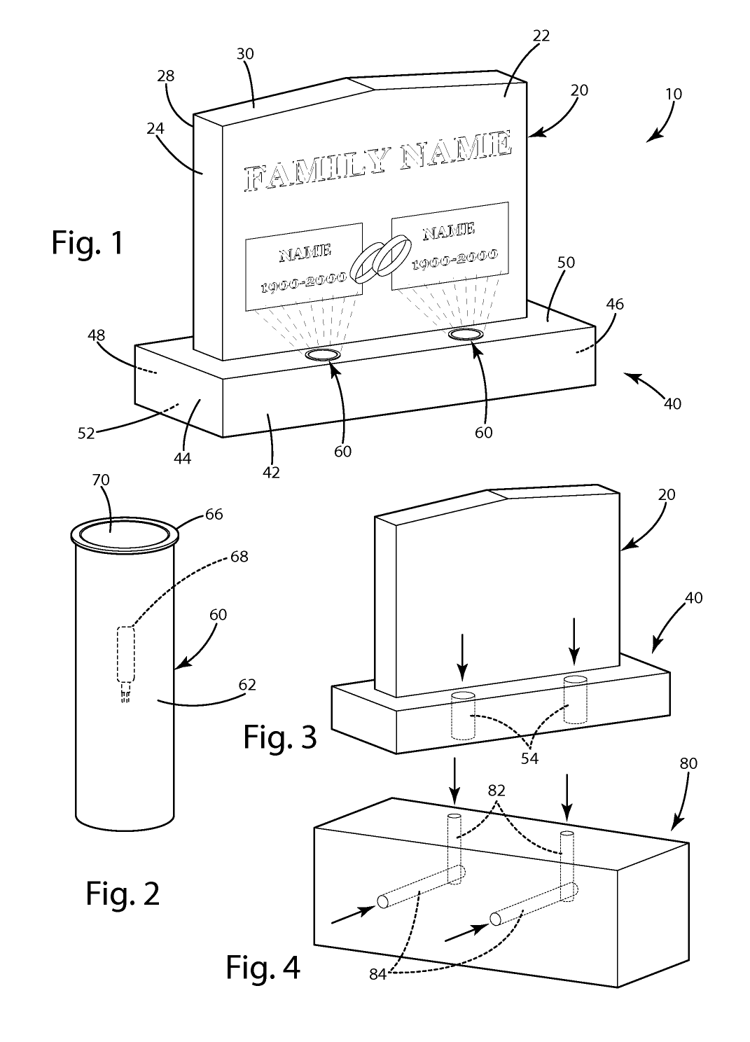

A first embodiment of a lighted memorial is shown in FIG. 1 and generally designated 10. The lighted memorial 10 may generally include a monument portion 20, a base portion 40 and one or more light sources 60.

The illustrated monument portion 20 is roughly shaped as a rectangular solid and includes a monument front face 22, monument side faces 24, 26, a monument rear face 28 and a monument top face 30. The monument portion 20 may be other shapes, including any shape suitable for the application. For example, the monument may be a religious symbol such as a cross, or the monument may be a sculpture such as an angel. As illustrated, the monument top face 30 may be contoured such that a middle portion is raised relative to the two side portions. Other contours in top face 30 are also contemplated, including an oscillating wave, a smooth height variation, and an abrupt, angled height variation. Any of the faces 22-30 may be contoured, or may be substantially flat. Any of the faces 22-30 may have a substantially smooth surface, or a rough, unfinished surface. As shown in FIG. 1, the front face 22, side faces 24, 26 and the rear face 28 may be oriented substantially parallel to a vertical axis of the lighted memorial 10, with the front and rear faces 22, 28 substantially parallel to one another, and the side faces 24, 26 substantially parallel to one another. The faces 22-30 may optionally be at various angles with respect to one another. Further optionally, one or more of the faces 22-30 may be curved such that one or more of the faces 22-30 smoothly transition into one another. Information regarding the deceased and various graphics may appear in or on the monument portion 20. In the illustrated embodiment, the name of the deceased and a graphic design are carved into the monument front face 22. Any method of forming the information and graphics on or in the monument portion 20 may be used, including carving, etching and printing.

The base portion 40 may be positioned below the monument portion 20 and may generally support the monument portion 20. The base portion 40 and the monument portion 20 may be one piece, or may be separate. The monument portion 20 may be attached or connected to the base portion 40, or may simply be placed on top of the base portion 40 and maintained in place by its weight. The base portion 40 may include a base front face 42, base side faces 44, 46, a base rear face 48 and a base top face 50. As illustrated, the base front face 42, base side faces 44, 46 and base rear face 48 may be configured substantially as a rectangular solid. Optionally, the base faces 42-48 may be oriented at an angle relative to the vertical axis, and further optionally may be angled inward, toward the monument portion 20. Other angular configurations are also contemplated. In the illustrated embodiment, the base top face 50 is roughly or substantially parallel to the monument top face 30, although these faces may optionally be oriented at an angle to one another. One or more recesses 54 may be defined in the base portion 40 through the base top face 50 for receiving one or more light sources 60. As shown in FIG. 1, the illustrated embodiment includes two recesses 54 substantially equally spaced along base portion 40, but any suitable number of recesses 54 and spacing configuration may be used depending on the desired lighting. The illustrated recesses 54 have an axis that is oriented substantially parallel to the vertical axis of the lighted memorial 10 and substantially perpendicular to the base top face 50. Optionally, the recesses 54 may be oriented at an angle relative to the vertical axis, including angled inward toward the monument portion 20 and substantially parallel to the base front face 42. Further optionally, the recesses 54 may be oriented substantially parallel to one another, or at an angle to one another, including angled toward one another. The illustrated recesses 54 are positioned adjacent the monument front face 22, but it is contemplated that the recesses 54 may be positioned adjacent any of the other faces 24-28 in addition to or instead of the front face 22. The recesses 54 may be any shape suitable to receive the one or more light sources 60, including substantially cylindrical, as shown in FIG. 1.

The one or more light sources 60 may be positioned at least partially within the one or more recesses 54. The light sources 60 may be friction fit within the recesses 54, or secured using any other suitable method. For example, the light sources 60 may be threaded into the recesses 54 or may be adhered using any of a variety of adhesives. As shown in FIG. 2, each of the illustrated light sources 60 includes a casing 62, a lip 66, a light 68 and a lens 70. The casing 62 generally receives and protects the light 68 and generally defines the shape of the light source 60. The shape of the casing 62 may be any shape suitable to be received in the recess 54, including substantially cylindrical, as illustrated in FIG. 2. The lip 66 is positioned at one end of the casing 62 and generally extends outward from the casing 62. Upon installation, the lip 66 may be placed adjacent and engage the base top face 50 to ensure a secure fit and proper positioning of the light source 60. For example, the lip 66 may positively position the light source 60 at a proper depth within recess 54. Optionally, the lip 66 may also prevent water and debris from entering the recess 54. The light 68 is positioned within the casing 62 and is covered and protected by a transparent or translucent lens 70. The light 68 may be any suitable light, including a light emitting diode (LED), incandescent bulb, halogen bulb and fluorescent bulb. The lens 70 may be any shape suitable for the application, including substantially flat and curved. Optionally, the lens 70 may be designed to allow a maximum amount of light through while maintaining sufficient protection from the weather. Further optionally, the lens 70 may be designed to allow less than a maximum amount of light through to soften or otherwise affect the transmitted light.

As with the recesses 54, the light sources 60 may be oriented substantially parallel to one another and substantially parallel to a vertical axis of the lighted monument 10, or may have another angular configuration. For example, the light sources 60 may optionally be angled inward toward the monument, and may further optionally be angled toward one another. If the light sources 60 are angled toward one another, the angle may be selected so that the light sources 60 at least partially illuminate the same section of the monument portion 20. The illustrated light sources 60 are positioned adjacent the monument front face 22 and illuminate information regarding the deceased, but it is contemplated that the light sources 60 may be positioned adjacent any of the other faces 24-28 in addition to or instead of the front face 22. More or fewer light sources 60 may be used, depending on the desired lighting. Any suitable configuration for activating and deactivating the lights may be used. Optionally, the light sources 60 may be equipped with a photosensor, which automatically turns the light sources 60 on when it is dark and off when it is light. Further optionally, the light sources 60 may be equipped with a timer that automatically turns the light sources 60 on and off based on the time of day. Even further optionally, a photosensor or timer may be positioned at the power source so that multiple light sources 60 are controlled simultaneously.

A foundation 80 may be positioned below the base portion 40 and may generally support the base portion 40 and the monument portion 20. The foundation 80 may be any shape suitable to support the base portion 40 and monument portion 20, including a rectangular solid, as illustrated. The base portion 40 may be connected or attached to the foundation 80, or the base portion 40 and monument portion 20 may simply be placed on top of the foundation 80 and held in place by their weight. As illustrated in FIG. 4, the foundation 80 may have one or more recesses 82 that align with recesses 54 to receive wiring 90 from the light sources 60. The recesses 82 may extend partially or completely through the foundation 80. If the lighted memorial 10 uses hard wired power, one or more recesses 84 may connect to the recesses 82 to route the wiring 90 out of the foundation 80. Other options for powering the light sources 60 are possible and are described below. Corresponding recesses 82, 84 may be formed in the foundation 80 to accommodate more light sources 60.

The monument portion 20, base portion 40 and foundation 80 may be made of any suitable material, including concrete, iron, limestone, sandstone, slate, bronze, marble and granite. The casing 60 and lip 62 may be made of any suitable material, including bronze, plastic and iron.

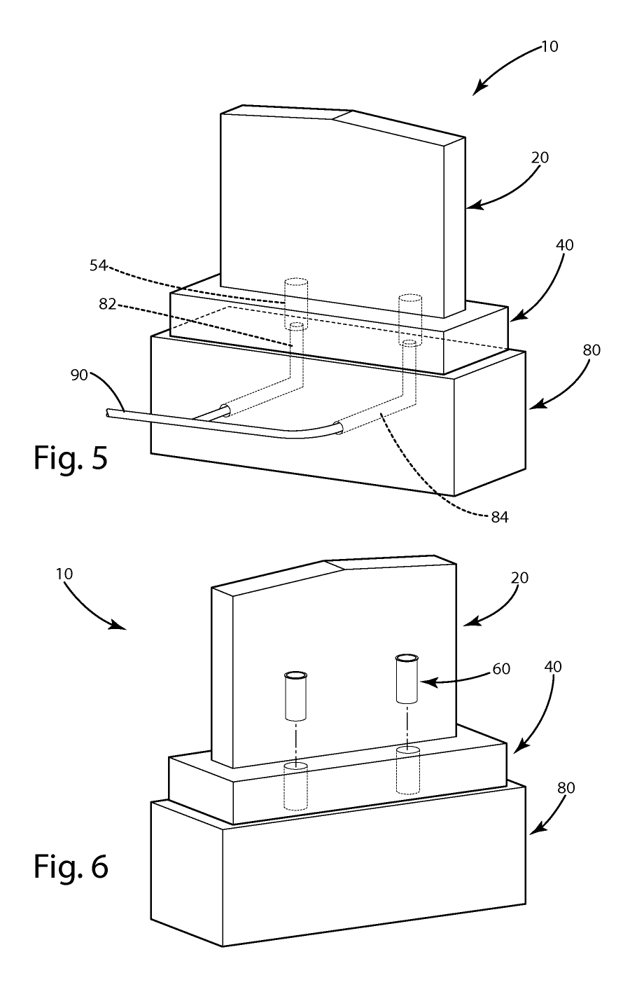

The process for manufacturing the lighted memorial 10 is generally illustrated in FIGS. 3-6. After formation of the monument portion 20 and the base portion 40, the one or more recesses 54 may be formed in the base portion 40 by drilling, punching or any other suitable process. If hard wired power is used, the one or more recesses 82, 84 may be formed in foundation 80 using any suitable process. The monument portion 20 and base portion 40 may then be placed on top of the foundation 80 and the recesses 54 may be aligned with the recesses 82. Wires may then be routed through the recesses 54, 82, 84 and connected between a power source and the light sources 60. As further described below, the wires may have a different routing if other power sources are used. The light sources 60 may be inserted into the recesses 54 and secured using a friction fit, adhesive, or any other suitable method.

### III. Second Embodiment

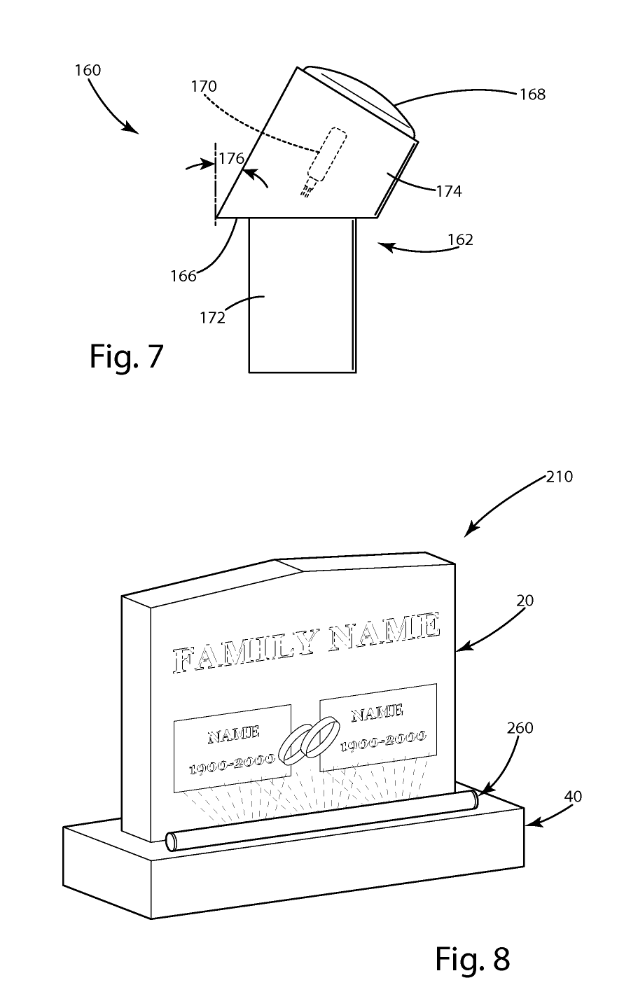

A light source associated with a second embodiment of the present invention is shown in FIG. 7 and generally designated 160. The light source 160 may be used in conjunction with the monument portion 20, the base portion 40, the foundation 80 and the wiring 90 described in connection with the first embodiment. These features will not be described here.

As shown in FIG. 7, the light source 160 has a casing 162, a light 170 positioned within casing 162, and a lens 168. The casing 162 may be divided into two or more portions, including a lower casing 172 and an upper casing 174, as illustrated. The upper casing 174 may be oriented at an angle 176 relative to the lower casing 172. The angle 176 may be any suitable angle to provide a desired level and location of lighting.

As shown in FIG. 7, the circumference of the upper casing 174 may be greater than the circumference of the lower casing 172 such that a lip 166 is formed at the junction between the upper casing 174 and the lower casing 172. As with the first embodiment, the lip 166 may be placed adjacent and engage the base top face 50 to positively position the light source 160. Optionally, the circumference of the upper casing 174 may be substantially equal to the circumference of the lower casing 172, and the angular junction between the upper casing 174 and lower casing 172 may be used to properly position the light source 160. The embodiment illustrated in FIG. 7 includes a dome-shaped, convex lens 168. It is also contemplated that the lens 168 may have any suitable shape, including the shapes described above in connection with the first embodiment. The second embodiment may be manufactured using any suitable materials and processes, including those described above in connection with the first embodiment.

### IV. Third Embodiment

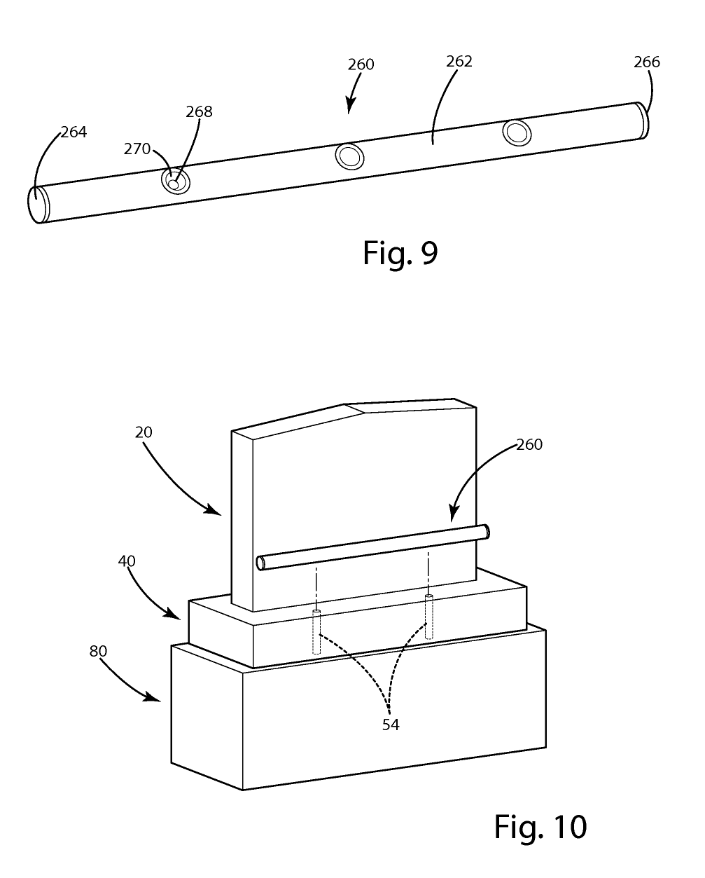

A third embodiment of a lighted memorial is shown in FIGS. 8-10 and generally designated 210. The lighted memorial 210 generally includes a light source 260. The monument portion 20, base portion 40, foundation 80 and wiring 90 for the third embodiment may be essentially the same as these features as described above in connection with the first and second embodiments. Accordingly, these elements will not be described here.

As shown in FIG. 8, the light source 260 may be a light bar. The light source 260 may include a casing 262 having two end caps 264, 266, a lens 268 and a light 270. The light 270 may be a single bulb, or multiple bulbs spaced along the length of the casing, depending on the desired level of lighting. The light 270 may be any type suitable for the application, including those mentioned above. The casing 262 may include any suitable anchoring system, including one that interacts with the one or more recesses 54 formed in base portion 40. For example, the casing 262 may define a plug that fits into and secures with the recess 54. Optionally, other mounting hardware may extend into the recess 54. Wiring 90 may also extend through the recesses 54, 82, 84 to reach a power source. Optionally, two plugs may anchor the light source 260, as illustrated in FIG. 10. Further optionally, any other suitable securing mechanism may be used, including threaded fasteners, snap-fit fasteners and adhesives. The third embodiment may be manufactured using any suitable materials and processes, including those described above.

### V. Fourth Embodiment

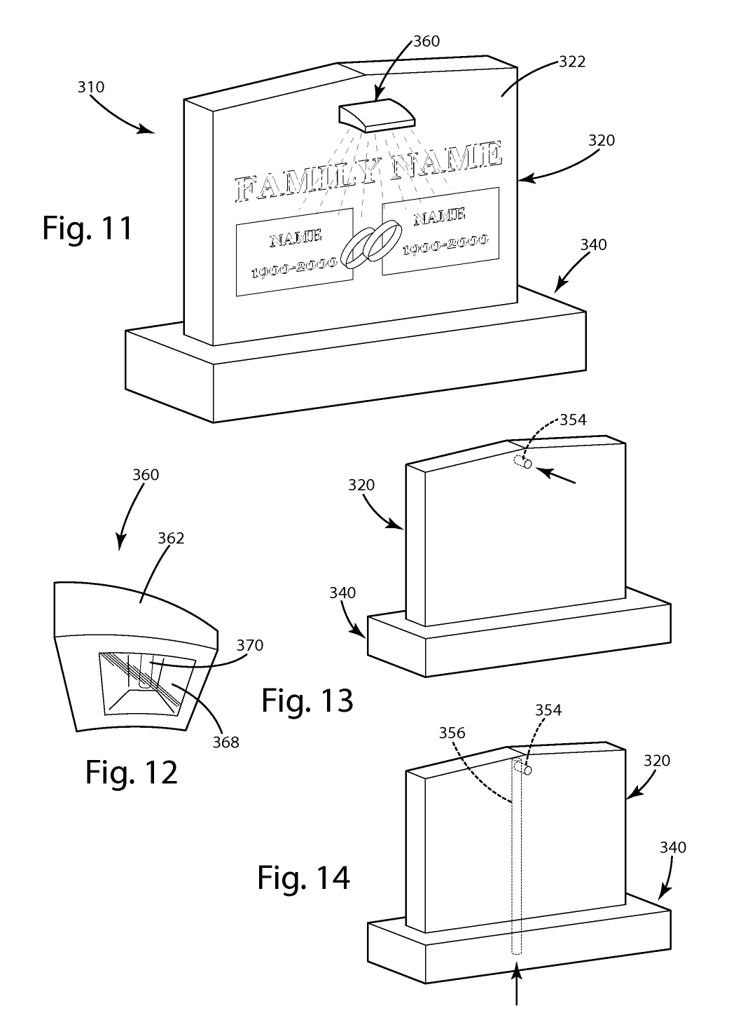

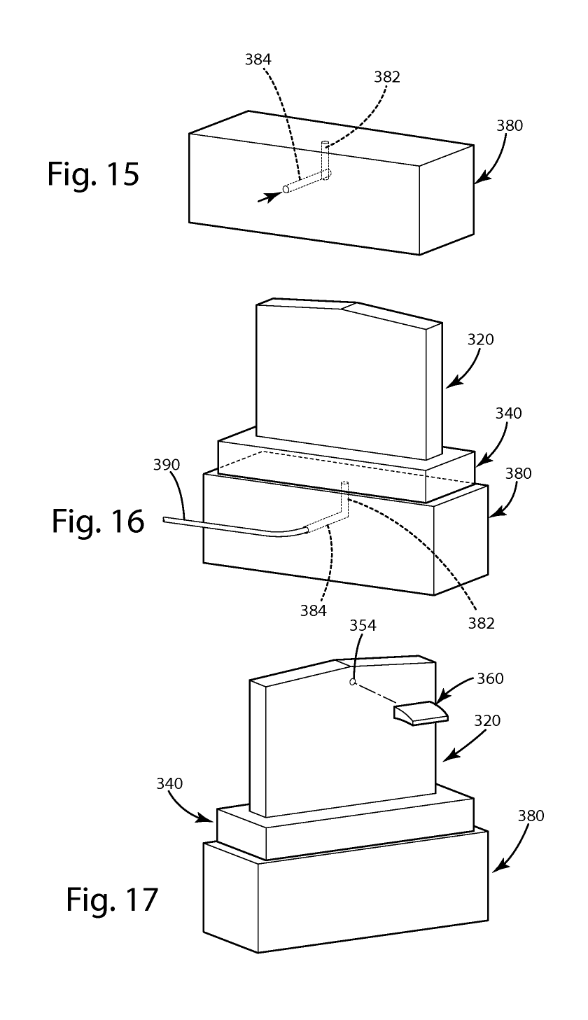

A fourth embodiment of a lighted memorial is shown in FIGS. 11-17 and generally designated 310. The lighted memorial 310 generally includes a light source 360. The lighted memorial 310 generally includes a monument portion 320, a base portion 340, a foundation 380 and wiring 390 that include many of the characteristics described above. Accordingly, many of the features of these elements will not be described here.

As shown in FIG. 11, the light source 360 may be positioned on the monument front face 322, and optionally at the top of the monument front face 322 above the information regarding the deceased. The light source 360 may include a casing 362, a lens 368 and a light 370. The casing 362 may be any suitable shape, including a shape that is thicker adjacent the monument front face 322 and thinner opposite the monument front face 322, as shown in FIG. 12. As with the other embodiments, more than one light source 360 may be used depending on the desired level of lighting. The casing 362 may include any suitable anchoring system, including one that interacts with a recess 354 in the monument front face 322, as shown in FIG. 17. For example, the casing 362 may include a plug similar to that described in connection with the third embodiment. Optionally, the plug may be secured in monument portion 320 using any suitable securing mechanism, including those discussed above. Wiring 390 may extend from the light source 360, through the plug into recess 354 and into a central channel 356 defined through base portion 340 and into monument portion 320. The wiring 390 may extend from central channel 356 into recesses 382, 384 and out of the foundation 380 to a power source.

The process for manufacturing the lighted memorial 310 is generally illustrated in FIGS. 13-17. After formation of the monument portion 320 and the base portion 340, the recess 354 and central channel 356 may be formed in the base portion 340 and foundation 380 by drilling, punching or any other suitable process. If hard wired power is used, the recesses 382, 384 may be formed in foundation 380 using any similar processes. The monument portion 320 and base portion 340 may then be placed on top of the foundation 380 and the central channel 356 may be aligned with the recess 382. Wires 390 may then be routed through the recess 354, central channel 356 and recesses 382, 384 and connected between a power source and the light source 360. As further described below, the wires 390 may have a different routing if other power sources are used. The light source 360 may be inserted into the recess 354 and secured using a friction fit, adhesive, or any other suitable method.

### VI. Fifth Through Eighth Embodiments

The fifth through the eighth embodiments include variations on the above embodiments. Many features in these embodiments will be similar to the above embodiments. Accordingly, the features already described above will not be described here.

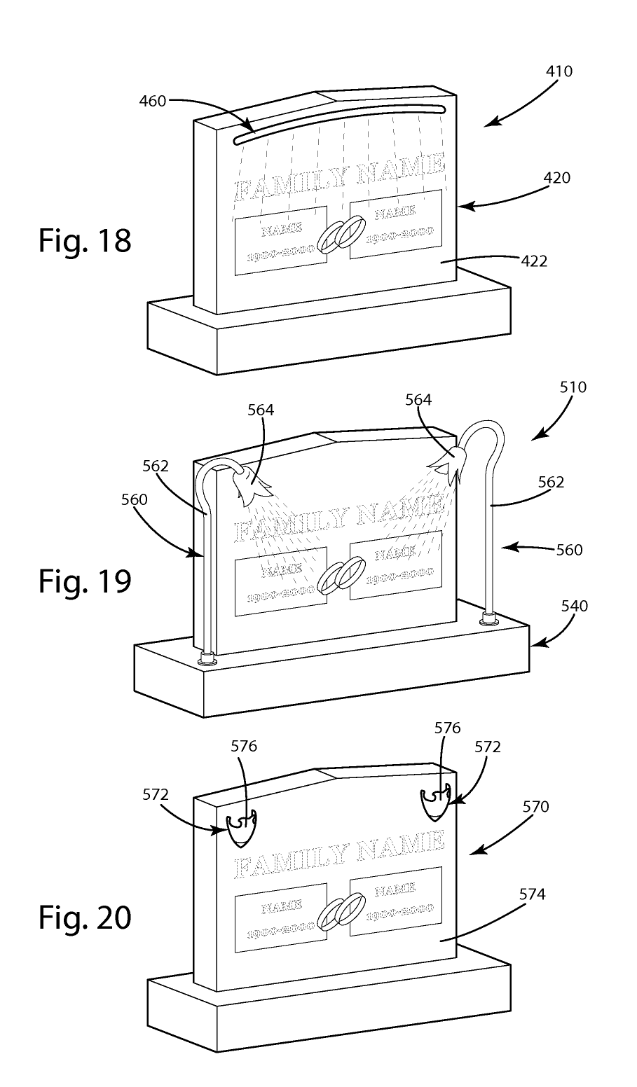

A fifth embodiment of a lighted memorial is shown in FIG. 18 and generally designated 410. The lighted memorial 410 includes a light source 460 positioned on or adjacent to the monument front face 422. The light source 460 may be formed in any suitable configuration, including a curved light bar as illustrated. Optionally, the light bar 460 may approximately match the contour of the top of the monument portion 420. Further optionally, the light bar 460 may be substantially straight, or may be any other suitable shape for the application. As illustrated, the light bar 460 may be positioned adjacent the top of the monument portion 420 above the information regarding the deceased.

A sixth embodiment of a lighted memorial is shown in FIG. 19 and generally designated 510. The lighted memorial 510 includes one or more light sources 560. Each light source 560 may have an elongated bar 562 mounted to and extending from the base portion 540 and a shade 564 with a light 570. As shown in FIG. 19, the bar 562 may include a straight portion and a curved portion configured to position the light 570 in a desired location.

A seventh embodiment of a lighted memorial is shown in FIG. 20 and generally designated 570. The lighted memorial 570 includes one or more light sources 572 positioned on the monument front face 574. The illustrated light sources 572 are formed as sconces that open upwards, and therefore may provide relatively soft light through the lenses 576 to the writing on the front face 574. However, it is contemplated that the light sources 572 may be another configuration, for example, a configuration that opens downward, toward the writing on the front face 574. The material and shape of the lenses 576 may be configured to provide desired lighting characteristics.

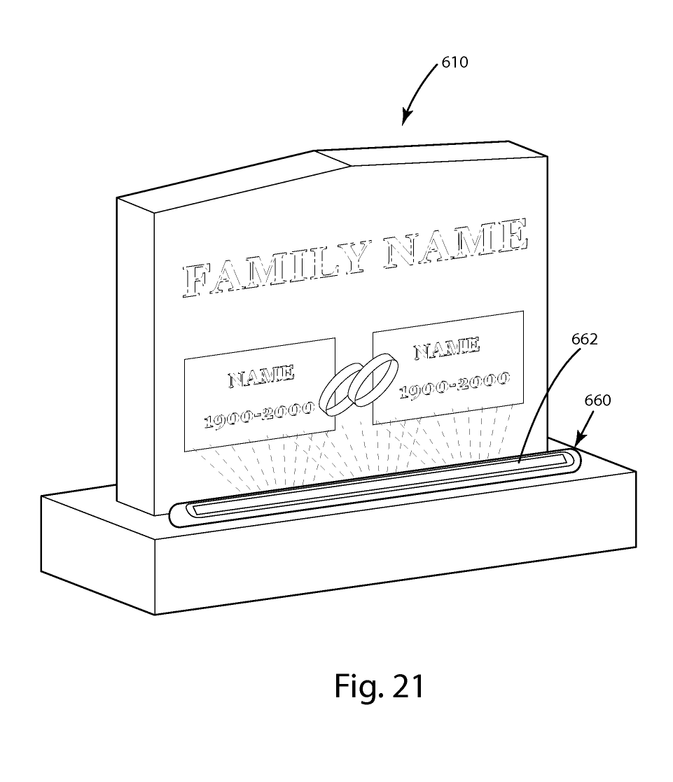

An eighth embodiment of a lighted memorial is shown in FIG. 21 and generally designated 610. The lighted memorial 610 includes a light source 660, which is similar to the light source 260 in the third embodiment. Light source 660 includes a solar panel 662, which provides power for the light source 660. Accordingly, the lighted memorial 610 may not define recesses or channels to route wiring. The light source 660 may be adhered or otherwise secured to the base portion 640 using any suitable method, including threaded fasteners, snap fittings, and friction fittings.

### VII. Power Options

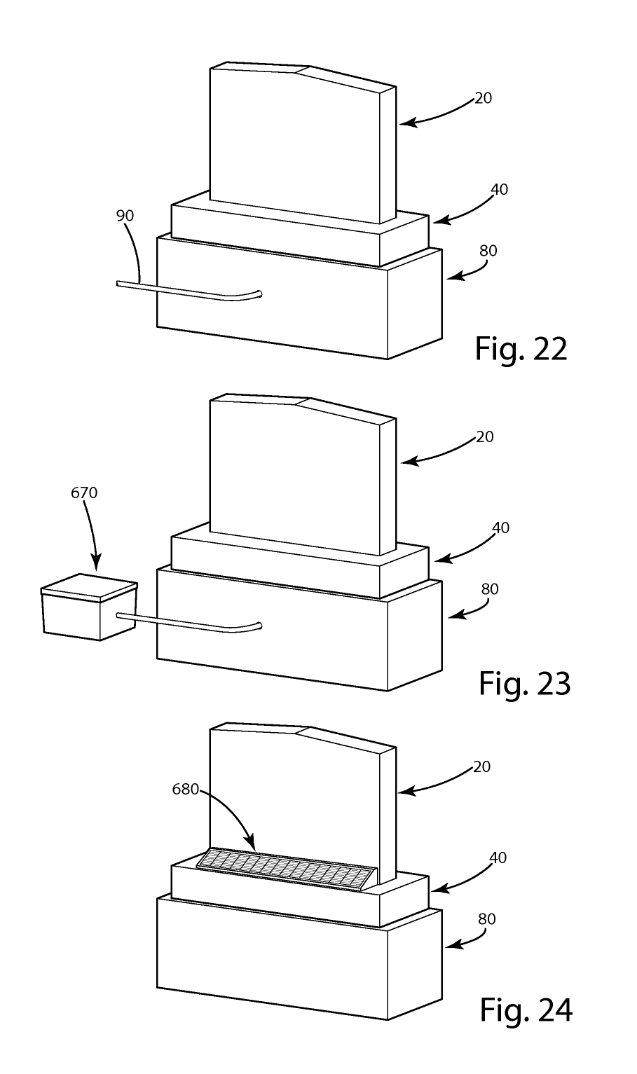

Various power options for the above embodiments of the invention are shown in FIGS. 22-24. A hard wired configuration is illustrated in FIG. 22, and has been described in connection with the above embodiments. The hard wired configuration includes recesses and/or channels formed in the monument portion 20, base portion 40 and foundation 80. Wiring 90 may be connected to the light source 60, routed through the recesses and/or channels, routed out of the foundation 80 and connected to a power source. In this configuration, the foundation may be partially or completely underground, so the wiring 90 may be concealed from view. In this configuration, the power source may be any suitable power source, including power supplied by a cemetery.

A battery powered configuration is shown in FIG. 23. The battery powered configuration may have similar recesses and/or channels formed in the monument portion 20, base portion 40 and foundation 80 to run wiring 90 from the light source 60, through the monument portion 20, through the base portion 40 and out of the foundation 80. A battery 670 may be buried adjacent the foundation 80 and connected to the wiring 90. The battery 670 may be placed in a protective housing, and may be positioned so it is accessible to replace the battery 670 when it is out of power.

A solar powered configuration is shown in FIG. 24. The solar powered configuration may include a solar panel 680. As illustrated, the solar panel 680 may be positioned on a rear side of the monument portion 20 so it is not visible when viewing the monument portion 20 from the front. Alternative mounting locations are considered for the solar panel 680, including on the monument top face 30 and on one of the other monument faces. In the solar powered configuration, some of the recesses and/or channels in the monument portion 20, base portion 40 and foundation 80 may be eliminated because the solar panel 680 generates the power for the light source 60. Optionally, wiring 90 may extend from the solar panel 680, through monument portion 20, to the light source 60. Capacitors, batteries or other power storage devices may be included to store the power generated by the solar panel 680.

### VIII. Ninth Embodiment

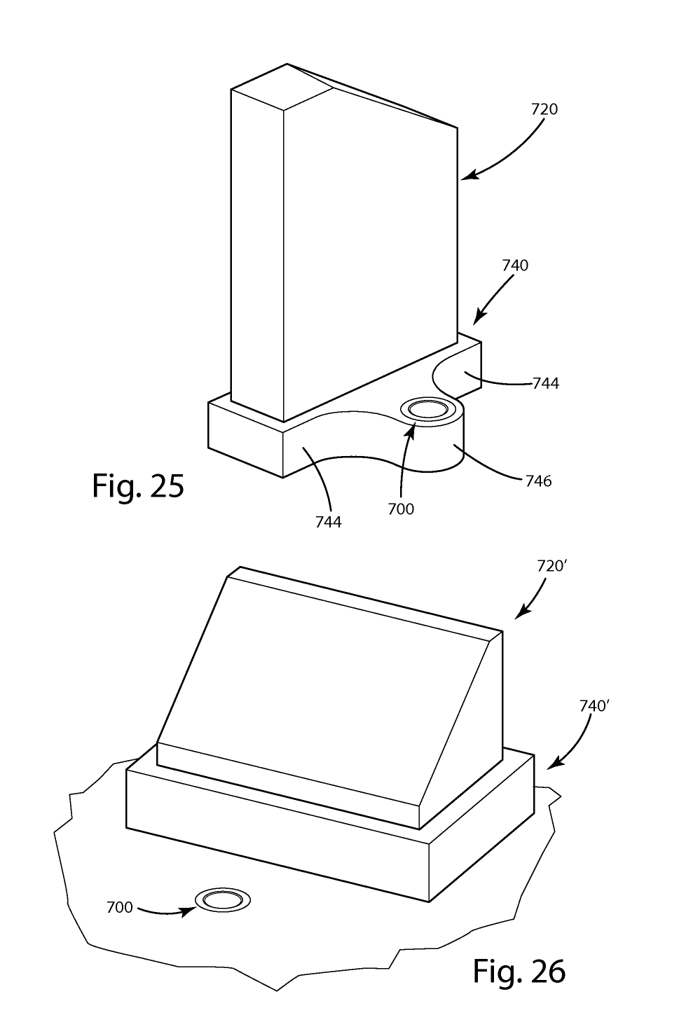

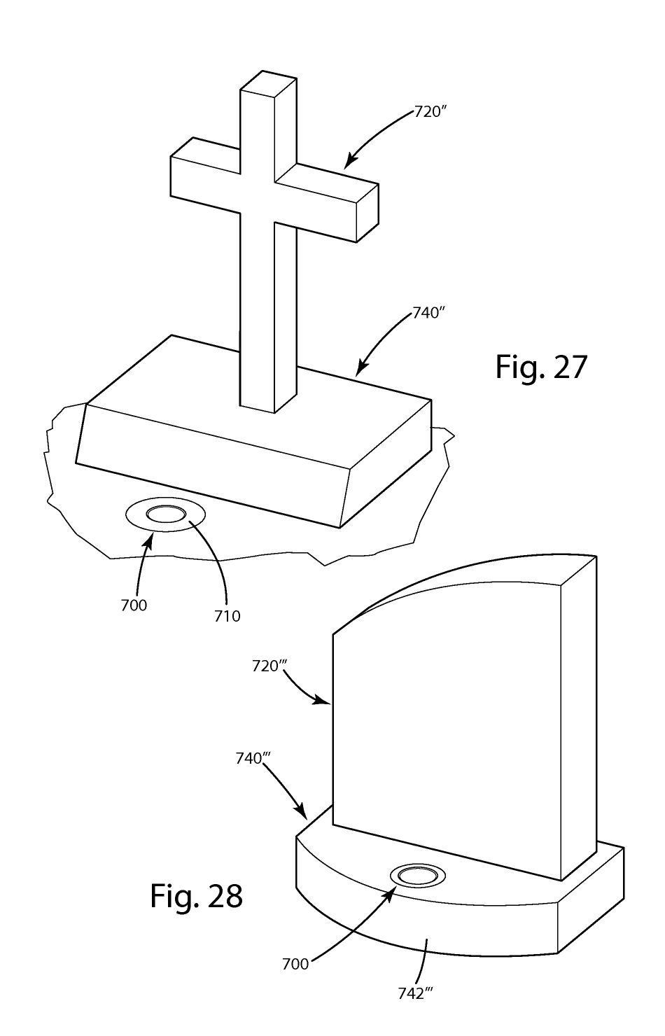

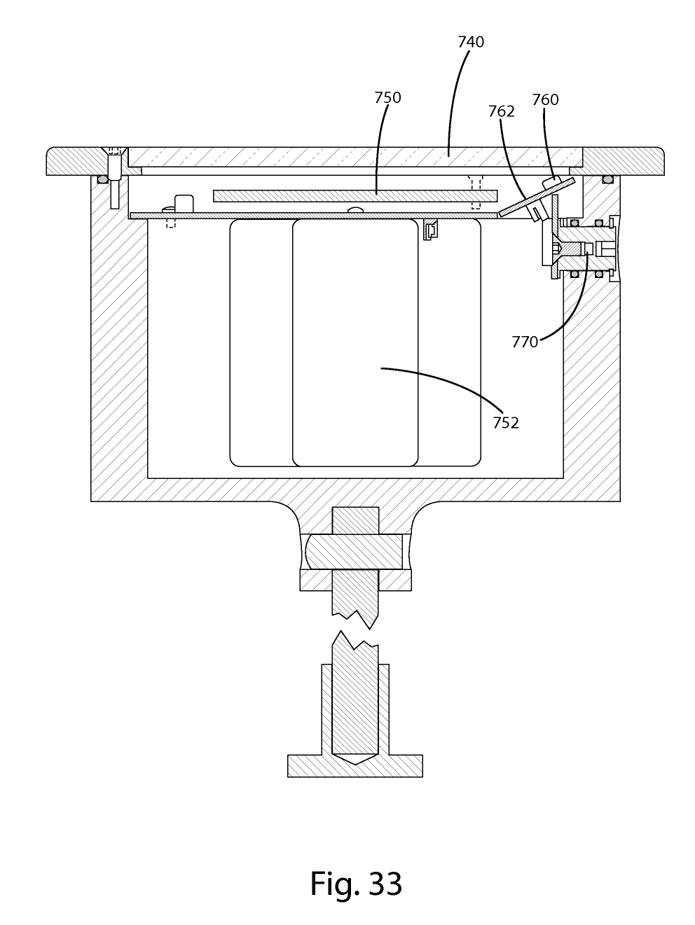

A ninth embodiment of a lighted memorial is shown in FIGS. 25-34 and generally designated 700. As shown in FIG. 25, the lighted memorial 700 may be mounted within a base portion 740 and may illuminate at least a portion of a monument portion 720. Optionally, the lighted memorial 700 may illuminate information regarding the deceased. As illustrated in FIG. 25, the base portion 740 may include a front face 742 that includes two substantially flat portions 744 and a substantially curved portion 746. The substantially curved portion may substantially match the curvature of the lighted memorial 700, so that a double arc effect is created. As shown in FIGS. 26-27, the lighted memorial 700 may be mounted in the ground or in another exterior surface and spaced from the monument portion 720′, 720″ and base portion 740′, 740″. In this configuration, the lighted memorial 700 may illuminate little or no portions of the monument portion 720′, 720″. Optionally, as shown in FIG. 27, the lighted memorial 700 may include a surround 710 to maintain the lighted memorial 700 at a desired height with regard to the surface and provide support for the lighted memorial 700. As shown in FIG. 28, the lighted memorial 700 may be mounted in a base portion 740′″ that includes a substantially smooth and continuously arced front surface 742′″.

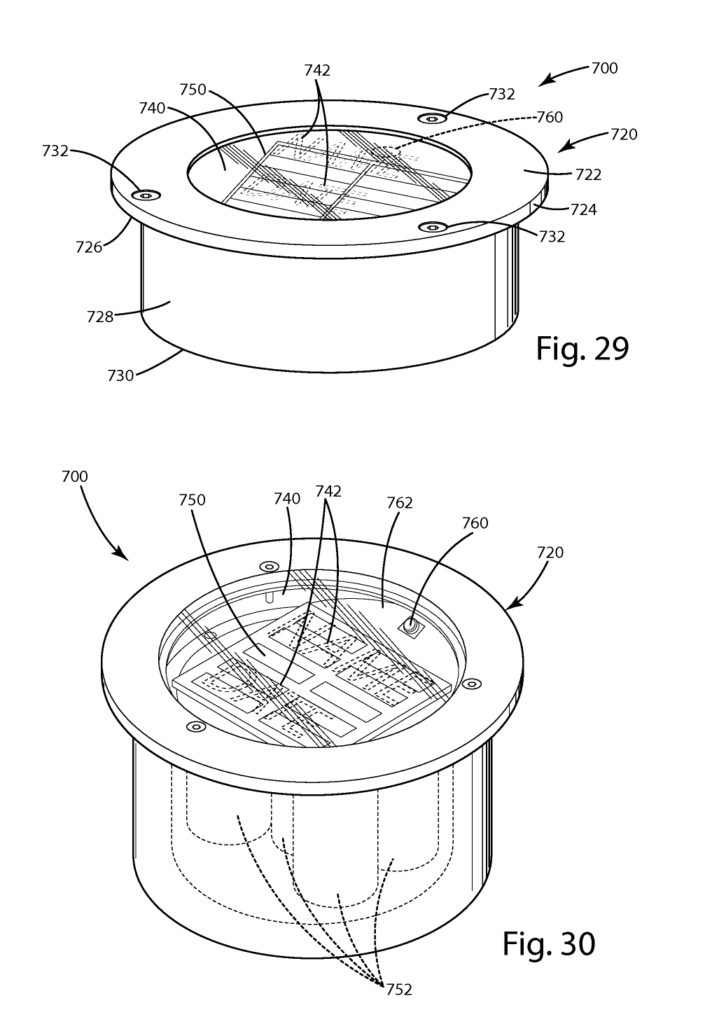

An enlarged view of the lighted memorial 700 is shown in FIG. 29. The lighted memorial 700 generally includes a housing 720, a lens 740 and at least one light source 760. The housing 720 may include a flange front face 722, a flange outer face 724, a flange rear face 726, a circumferential face 728 and a rear face 730. As illustrated, the flange front face 722, the flange rear face 726 and the rear face 730 may be substantially parallel to one another. The flange outer face 724 and the circumferential face 728 may be concentrically aligned with one another. Any other suitable configuration for the housing 720 is also considered. The housing 720 may be made with any suitable material including bronze, iron and composite, and may be formed using any suitable process.

The lens 740 can be a cover having at least a portion that is generally transparent or translucent to allow for light to pass through. As shown in FIG. 29, the lens 740 may be substantially parallel to the flange front face 722, the flange rear face 726 and the rear face 730, and may include an artistic design and/or alphanumeric characters 742. The characters 742 may be information regarding the deceased, including a name, birth date and date of death. The design and/or characters 742 may be formed on or in the lens 740 using any suitable method, including etching, printing and frosting. Optionally, the lens 740 may be void of any design or characters 742 and may be used to illuminate the monument portion 720 and/or the base portion 740. Further optionally, the lens 740 may include opaque areas and translucent or transparent areas that form desired alphanumeric characters and/or a design when the light source 760 shines through the lens 740. For example, most of the lens 740 may be opaque and the design and/or characters may be transparent or translucent so that the light shining through the lens 740 forms the design/characters. The lens 740 can be made of any suitable material, including glass and plastic, and may be secured with any suitable method, including one or more fasteners 732 inserted through the flange front face 722.

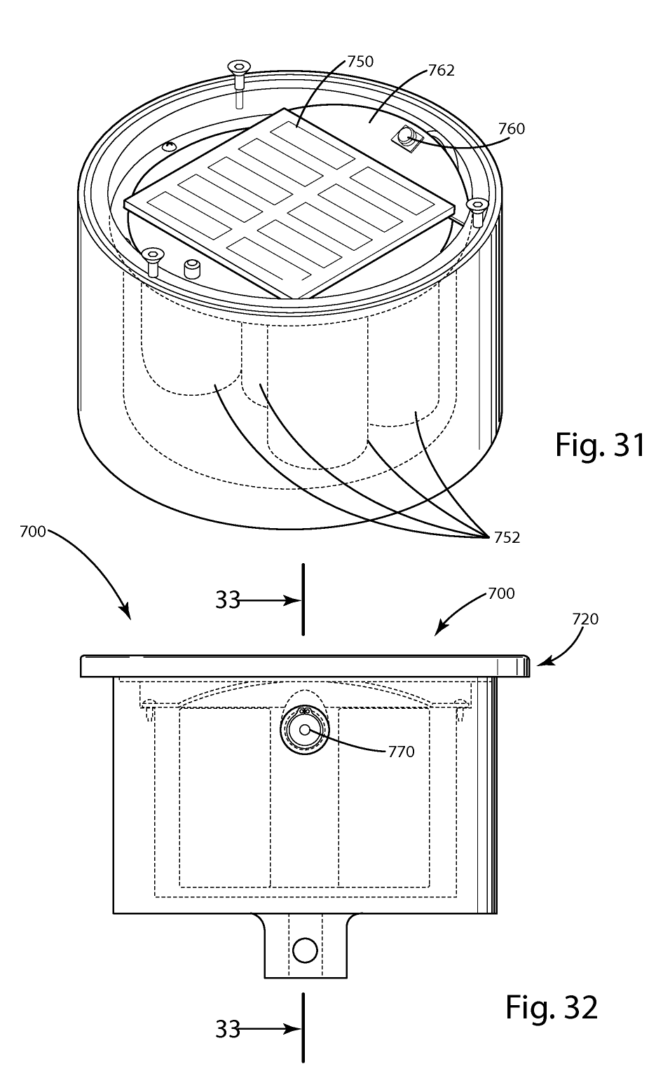

The light source 760 may be positioned below the lens 740 and may provide backlight for the lens 740. In this manner, the design and/or characters 742 may be illuminated or formed by the light source 760. The light source 760 may be any type suitable for the application, including those mentioned above in connection with the other embodiments. As shown in FIG. 31, the light source 760 may be positioned on a ramped surface 762. The ramped surface 762 may be oriented at a desired angle relative to the lens 740 based on the desired lighting characteristics. Other light sources may be positioned on the ramped surface 742, on other ramped surfaces, or elsewhere in the lighted memorial 700 to provide a desired level of lighting. Optionally, if more than one ramped surface and light source is included, the ramped surfaces may substantially aim the light sources at a single point positioned above the lens 740. Further optionally, the light source 760 may be positioned in front of the lens 740 to provide front lighting. Even further optionally, the light source 760 may be positioned at an edge of the lens 740 to provide edge lighting.

A solar panel 750 may be positioned below the lens 740 to harvest energy from the sun. As shown in FIG. 31, one or more capacitors, batteries or other power storage devices 752 may be connected to the solar panel 750 to store the energy harvested from the sun and supply the energy to the light source 760. Optionally, the power storage device 752 may be a supercapacitor. Further optionally, the lighted memorial 700 may be powered using any suitable source, including hard wiring and batteries.

In use, the solar panel 750 harvests energy from the sun during the daytime and the capacitors 752 store the harvested energy. During the nighttime the light source 760 activates via a photosensor, timer or other suitable switch mechanism. When the light source 760 activates, the capacitors 752 discharge energy to the light source 760 to power the light source 760. The light source 760 will deactivate when either the capacitors 752 have no power, or when it becomes daytime and the light source 760 is deactivated by the switch mechanism.

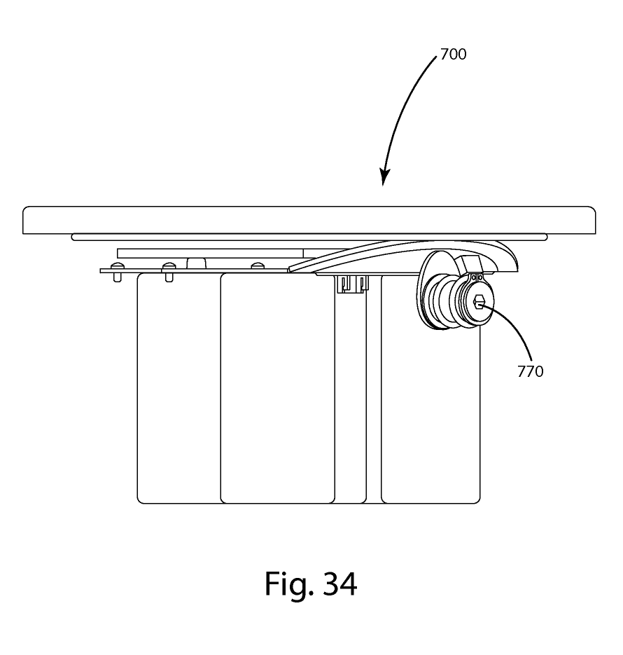

As shown in FIGS. 25-28 and discussed above, the lighted memorial 700 may be mounted in a variety of locations. For example, the lighted memorial 700 may be mounted in the monument portion 720 or in the base portion 740. In this configuration, the lighted memorial 700 may include a snap fastener 770, shown in FIG. 34, to secure the lighted memorial 700. The snap fastener 770 may be configured to be automatically compressed when the lighted memorial 700 is inserted into the monument portion 720 or base portion 740, and released when the snap fastener 770 drops below an edge defined in the monument portion 720 or base portion 740.

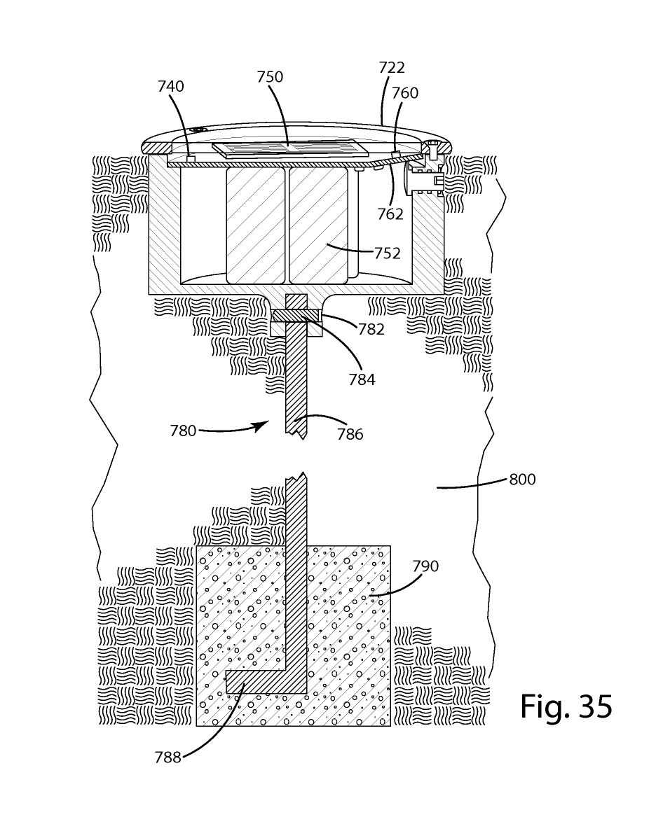

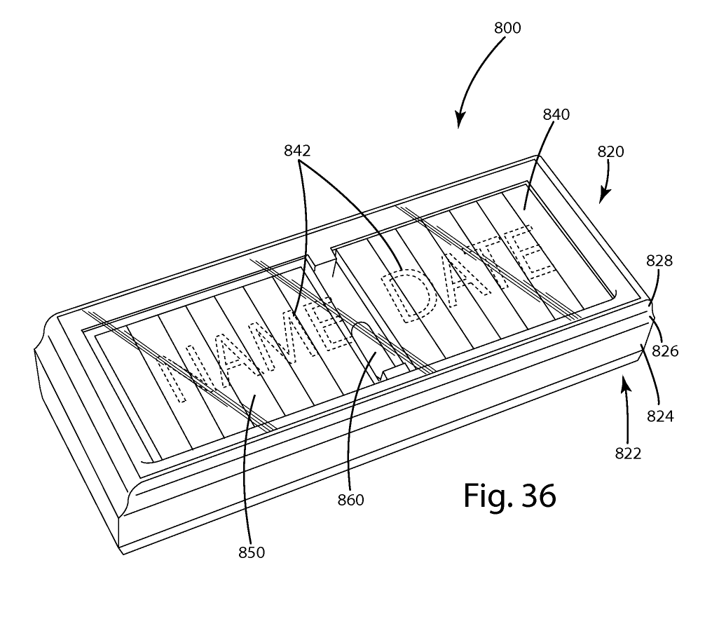

If the lighted memorial 700 is mounted in the ground, a theft deterrent anchor assembly 780 may be included, as shown in FIG. 35. The anchor assembly 780 may include a retaining element 784 for engaging a recess 782 defined in the housing and an anchor bar 786. The anchor bar 786 may be set in a rigid material 790 such as concrete, which may be positioned below the ground 800 to discourage the lighted memorial 700 from being removed from the ground. As shown in FIG. 35, the end of bar 786 may be bent to further retain the bar 786 within the rigid material 790. Any other suitable anchoring method may also be used.

### IX. Tenth Embodiment

A tenth embodiment of a lighted memorial is shown in FIG. 36 and generally designated 800. The lighted memorial 800 generally includes a housing 820, a lens 840 and at least one light source 860. The housing 820 may be any shape suitable for the application. For example, the housing 820 may be substantially brick-shaped as illustrated, or may be other shapes such as a triangular solid and a cube. The housing 820 may include one or more contoured faces 822. As shown in FIG. 36, contoured face 822 includes lower face 824, transition face 826 and upper face 828. As illustrated, the lower face 824 may protrude farther outward (away from the general brick-shape) than the upper face 828. The transition face 826 connects the upper face 828 and the lower face 824. The transition face 826 may include one or more smooth contours and/or abrupt, angled contours. Any other suitable configuration for the housing is also considered. The housing 820 may be made of any suitable material, including those mentioned above in connection with the other embodiments.

The lens 840 can be a cover having at least a portion that is generally transparent or translucent to allow for light to pass through. As shown in FIG. 36, the lens 840 may include an artistic design and/or alphanumeric characters 842. The characters may be information regarding the deceased, including a name, birth date and date of death. The design and/or characters 842 may be formed on or in the lens 840 using any suitable method, including etching, printing and frosting. Optionally, the lens 840 may be void of any design or characters 842. Further optionally, the lens 840 may include opaque areas and translucent or transparent areas that form a desired alphanumeric characters and/or design when the light source 860 shines through the lens 840. The lens 840 can be made of any suitable material, including glass and plastic. The lens 840 may be secured with any suitable method, including adhesives, threaded fasteners and snap-fittings.

The light source 860 may be positioned below the lens 840 and may provide backlight for the lens 840. In this manner, the design and/or characters 842 may be illuminated or formed by the light source 860. The light source 860 may be any type suitable for the application, including those mentioned above in connection with the other embodiments. As shown in FIG. 36, the light source 860 may be centered with the lens 840. Optionally, the light source 860 may be in any other suitable location. For example, the light source 860 may be positioned in front of the lens 840 to provide front lighting or the light source 860 may be positioned at an edge of the lens 840 to provide edge lighting.

A solar panel 850 may be positioned below the lens 840 to harvest energy from the sun. As with the ninth embodiment, one or more power storage devices may be connected to the solar panel 850 to store the energy harvested from the sun and supply the energy to the light source 860. Optionally, the lighted memorial 700 may be powered using any suitable source, including hard wiring and batteries.

In use, the solar panel 850 harvests energy from the sun during the daytime and the power storage devices store the harvested energy. During the nighttime the light source 860 activates via a photosensor, timer or other suitable switch mechanism. When the light source 860 activates, the power storage devices discharge energy to the light source 860 to power the light source 860. The light source 860 will deactivate when either the power storage devices have no power, or when it becomes daytime and the light source 860 is deactivated by the switch mechanism.

The lighted memorial 800 may be mounted in a variety of locations. For example, the lighted memorial 800 may be mounted in the monument portion 20 or in the base portion 40 as discussed above in connection with other embodiments. In this configuration, the lighted memorial 800 may include any suitable fastener to secure the lighted memorial 800, including adhesives, threaded fasteners and snap fittings. Optionally, the lighted memorial 800 may be mounted in the ground. If the lighted memorial 800 is mounted in the ground, the contoured faces 822 may assist in securing the lighted memorial 800. For example, in the illustrated embodiment, the lighted memorial 800 may be buried to a depth at which the lens 840 is approximately coplanar with the ground. In this configuration, the flanged outward design of the contoured face 822 may provide resistance to the lighted memorial 800 being removed from the ground. If upward removal or movement of the lighted memorial 800 is attempted, the transition face 826 may exert a force against a portion of the ground located directly above the transition face 826, which may assist in keeping the lighted memorial 800 secured in the ground. In the same manner, the transition face 826 may prevent accidental or natural movement of the lighted memorial 800. If the lighted memorial 800 is mounted in the ground, a theft deterrent anchor assembly may be included as described above in connection with the ninth embodiment. Optionally, any other suitable anchoring method may also be used.

### X. Eleventh Embodiment

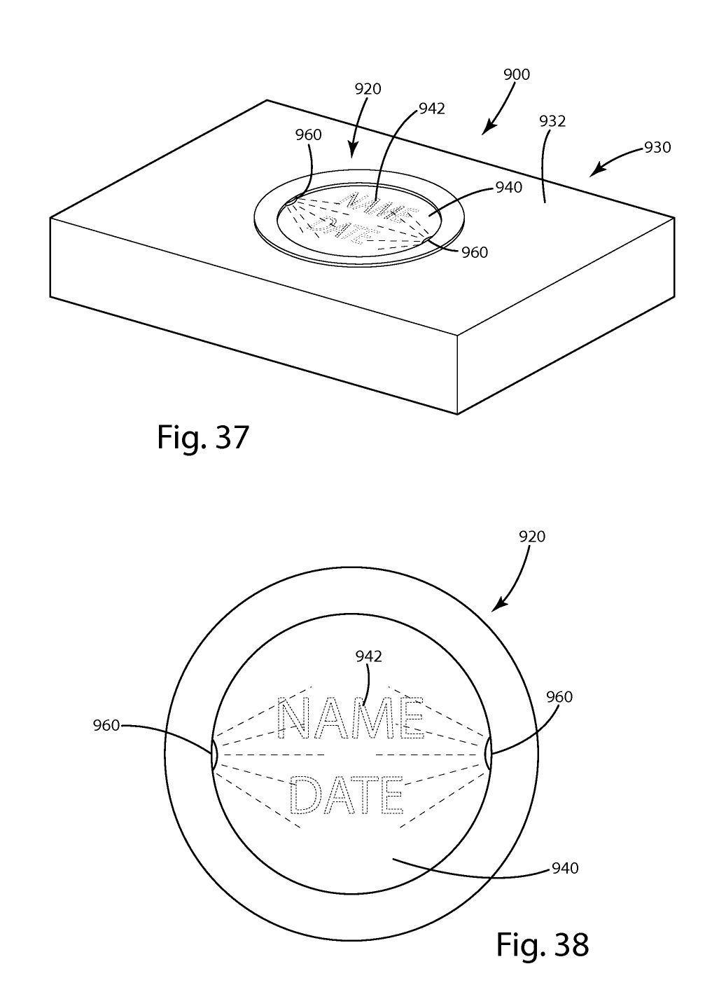

An eleventh embodiment of a lighted memorial is shown in FIGS. 37-42 and generally designated 900. The lighted memorial 900 may be used in connection with the cremated remains of a deceased. The lighted memorial 900 may generally include a housing 920, a base portion 930, a lens 940 and at least one light source 960. The base portion 930 may be any shape suitable for the application, including a rectangular solid with an angled top face 932, as illustrated in FIG. 37. The angled top face 932 may facilitate easier viewing of the lens 940. The base portion 930 may generally define a recess for receiving the housing 920. The housing 940 may be retained within the base portion 930 using any suitable method, including adhesives, fasteners and any method described in the above embodiments.

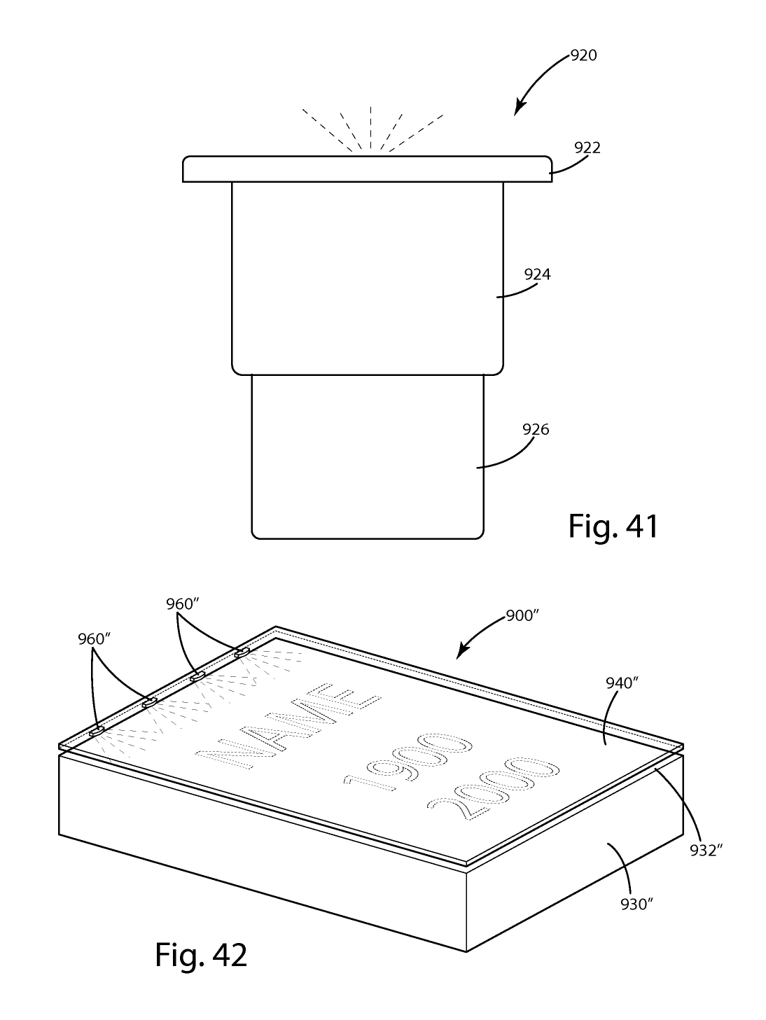

The housing 920 may be any shape suitable for the application. For example, the housing 920 may be substantially shaped as a cylinder with a varying diameter as illustrated, or may be other shapes. The housing 920 may include a light housing 924 for housing, containing or generally supporting the light source 960 and a remains housing 926 for housing or containing the cremated remains of the deceased. As shown in FIG. 41, the light housing 924 may include a top flange 922 positioned at the top of the light housing 924, and the light housing 924 may be positioned on top of the remains housing 926. As illustrated, the flange 922 may have a larger diameter than the remaining portion of the light housing 924, and the flange 922 and remaining portion of the light housing 924 may both have a larger diameter than the remains housing 926. The varying diameters may provide a positive positioning mechanism for the housing 920 within the base portion 930. For example, the base portion 930 may define a recess with steps corresponding to the differences in diameter so that the housing 920 is closely received within the base portion 930. In this manner, when a user engages the underside of the flange 922 with the base portion top surface 932, this may indicate that the housing 920 is fully inserted into the base portion 930. Any other suitable configuration for the housing 920 is also considered.

The lens 940 can be similar to the lenses described above in connection with other embodiments and may include an artistic design and/or alphanumeric characters 942. The lens 940 may be secured with any suitable method, including adhesives, threaded fasteners and snap-fittings. The housing 920, base portion 930 and lens 940 may be made from any suitable material, including those described above in connection with the other embodiments.

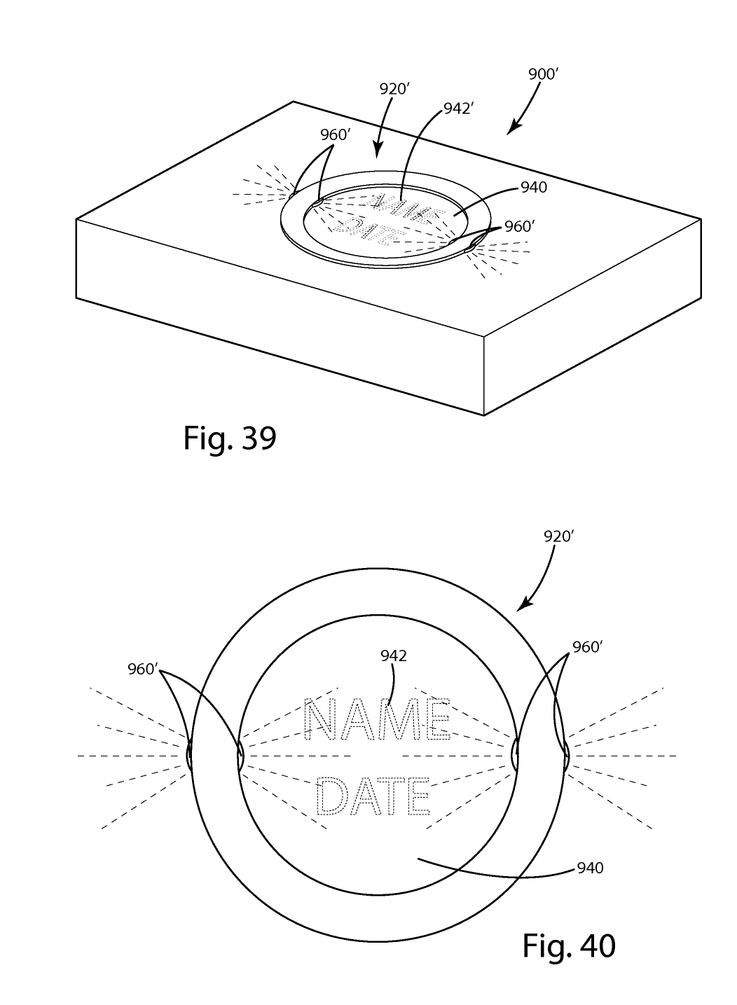

The light source 960 may be positioned below the lens 940 and may provide backlight for the lens 940. In this manner, the design and/or characters 942 may be illuminated or formed by the light source 960. The light source 960 may be any type suitable for the application, including those mentioned above in connection with the other embodiments. As shown in FIGS. 37-38, the lighted memorial 900 may include two light sources 960, each positioned adjacent opposite sides or edges of the lens 940 and generally facing toward each other. As shown in FIGS. 39-40, the lighted memorial 900′ may include four light sources 960′, with two light sources 960′ positioned adjacent opposite sides or edges of the lens 940 and generally facing toward each other, and two light sources 960′ positioned adjacent opposite sides or edges of the lens 940 and generally facing away from each other. In this manner, the light sources 960′ may be divided into pairs, with a first light source 960′ directed inward toward a center of the lens 940 and a second light source 960′ adjacent the first light source 960′ and pointing outward away from a center of the lens 940. It is contemplated that there may be more or less light sources 960 and that they may be placed at various positions adjacent the lens 940. For example, the light sources 960 may be positioned in front of the lens 940 to provide front lighting or the light sources 960 may be positioned at an edge of the lens 940 to provide edge lighting.

As shown in FIG. 42, the lighted memorial 900″ may include a lens 940″ that substantially covers the entire top face 932″ of the base portion 930. In this configuration, the light sources 960″ may be positioned below one or more edges of the lens 940″ to provide backlighting for the lens 940″. Optionally, the light sources 960″ may be positioned in any other suitable location, including above the lens 940″ to provide front lighting for the lens 940″ and at an edge of the lens 940″ to provide edge lighting for the lens 940″.

As described above in connection with the other embodiments, the light sources 960 may be powered using any suitable method, including a solar panel, hard wiring and batteries or other power storage devices. The lighting may be controlled using any suitable switch mechanism, including those described above in connection with the other embodiments.

### XI. Electronics

Various electronics configurations and electronic circuit designs may be used in association with the above embodiments. For example, electronics may be designed to control the power supplied to the light source. Optionally, the light source may be supplied with between approximately 40 and 800 mA. Further optionally, the light source may be an LED that is supplied with between approximately 40 and 800 mA. The electronics may be designed to control the intensity of the light source, to manage the photo cell, to manage/distribute power from the power source and/or to manage/distribute/control power from the power storage device to the other components of the lighted memorial. The electronics may also be designed to have wireless programmable capabilities (for example, Near Field Communication Technology). The electronics may be designed to withstand a wide range of environmental conditions that are present in the location where the lighted memorial will be positioned. Optionally, the electronics may be designed to withstand a temperature range of approximately −30 to 150 degrees Fahrenheit, to withstand up to approximately 80% humidity, and to last approximately 10 years.

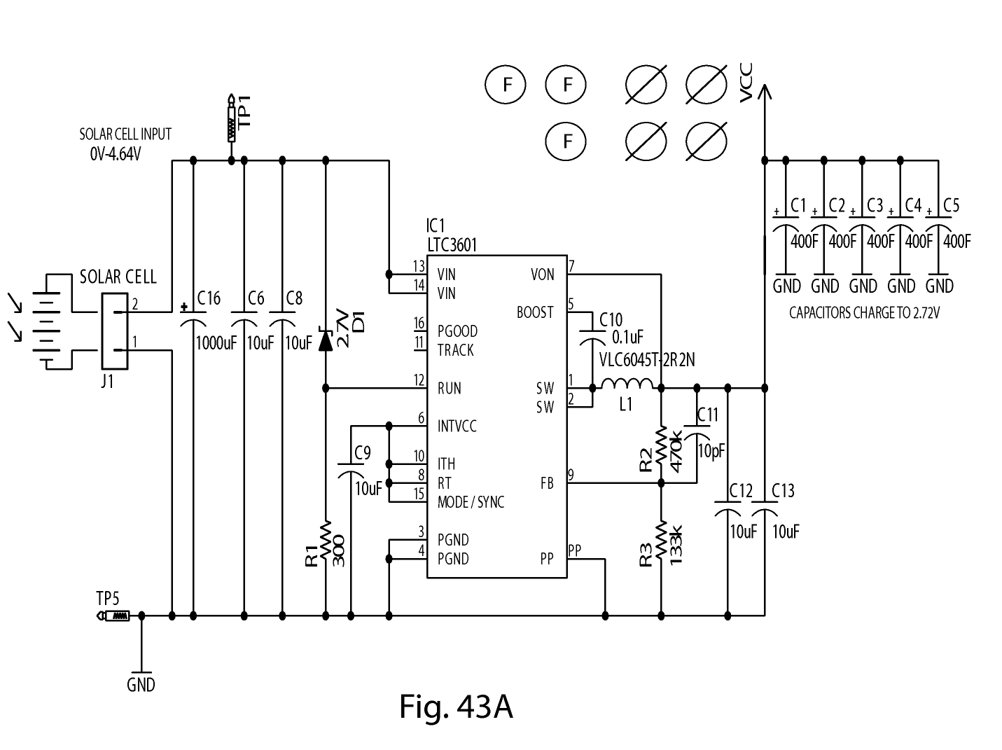

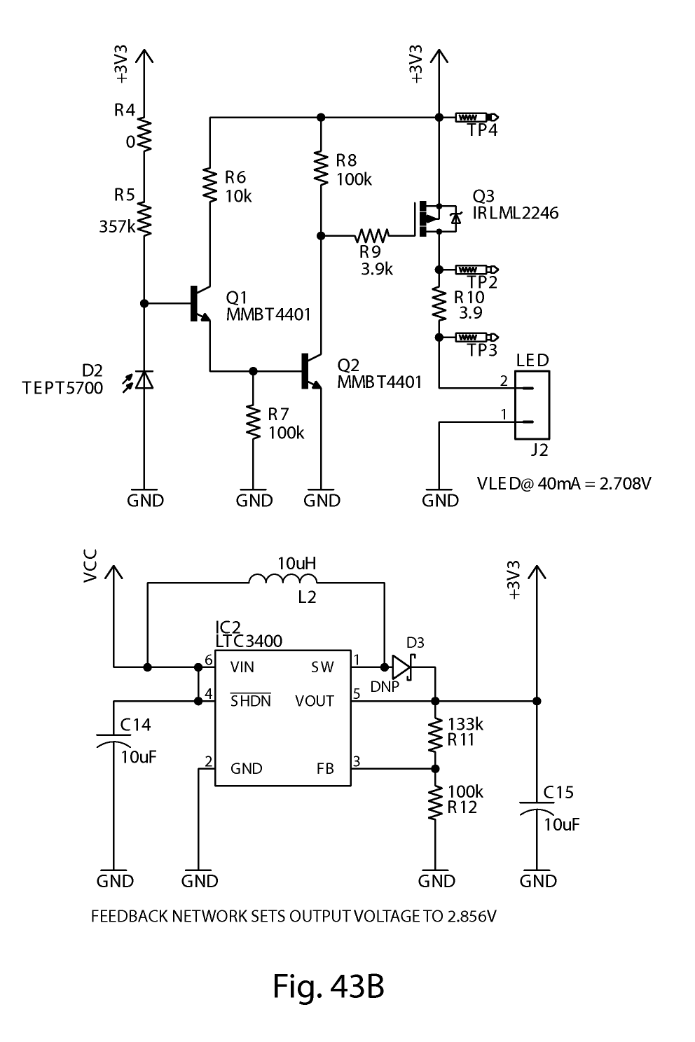

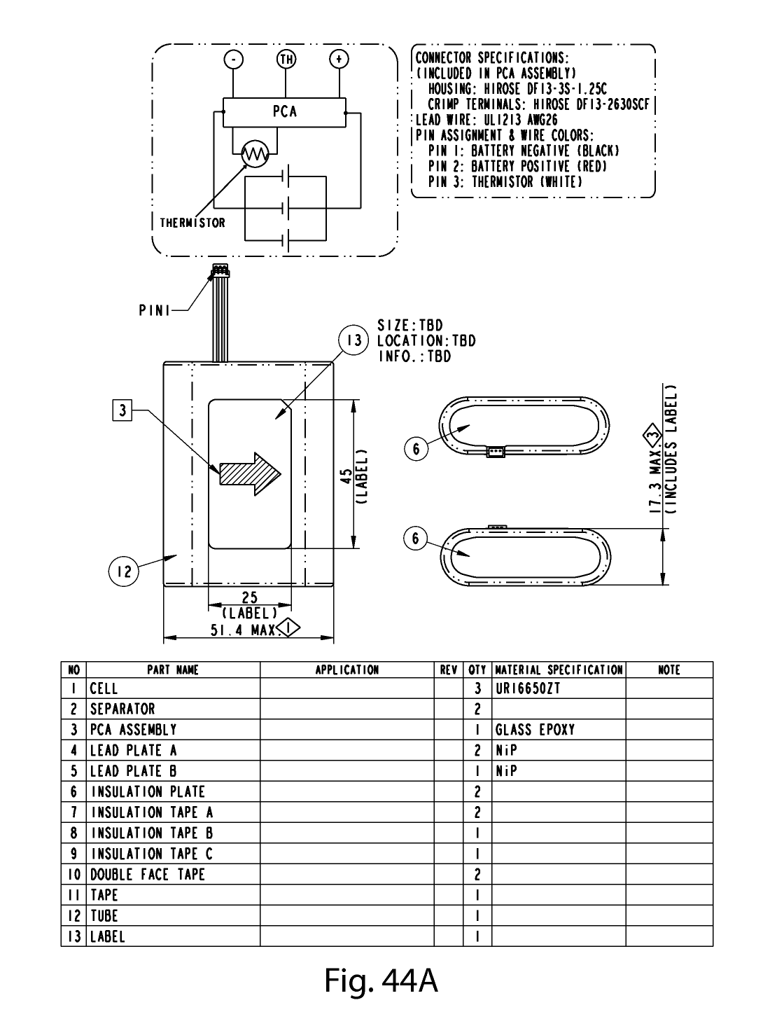

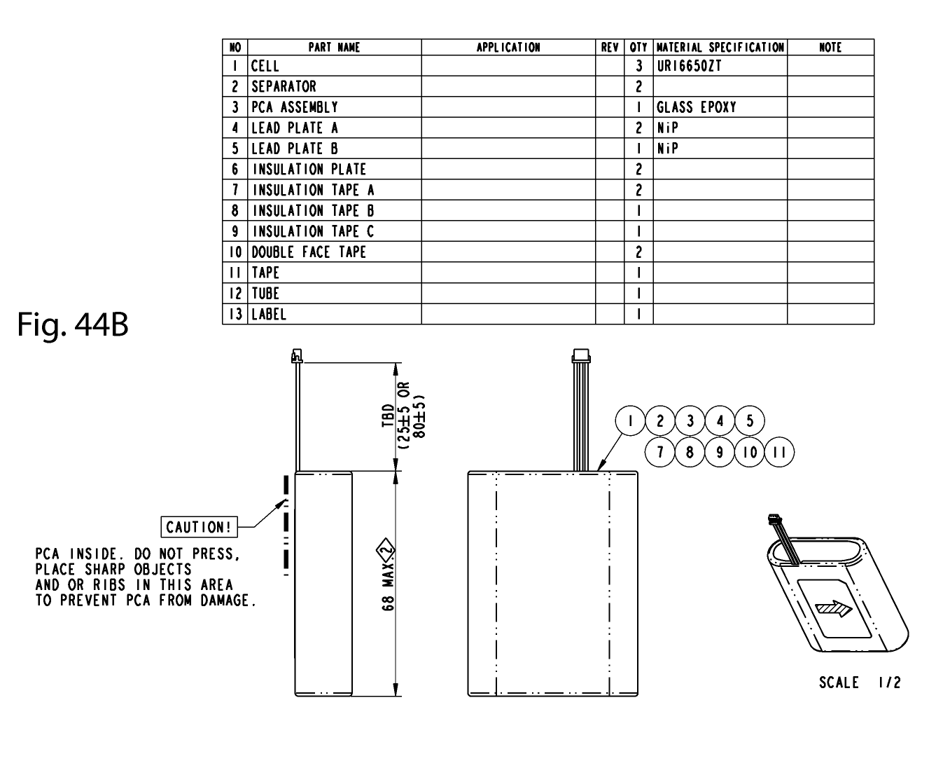

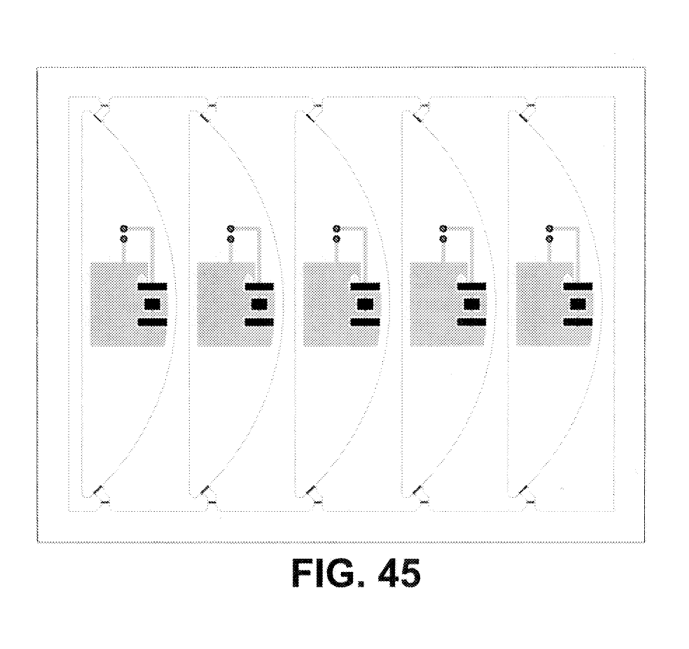

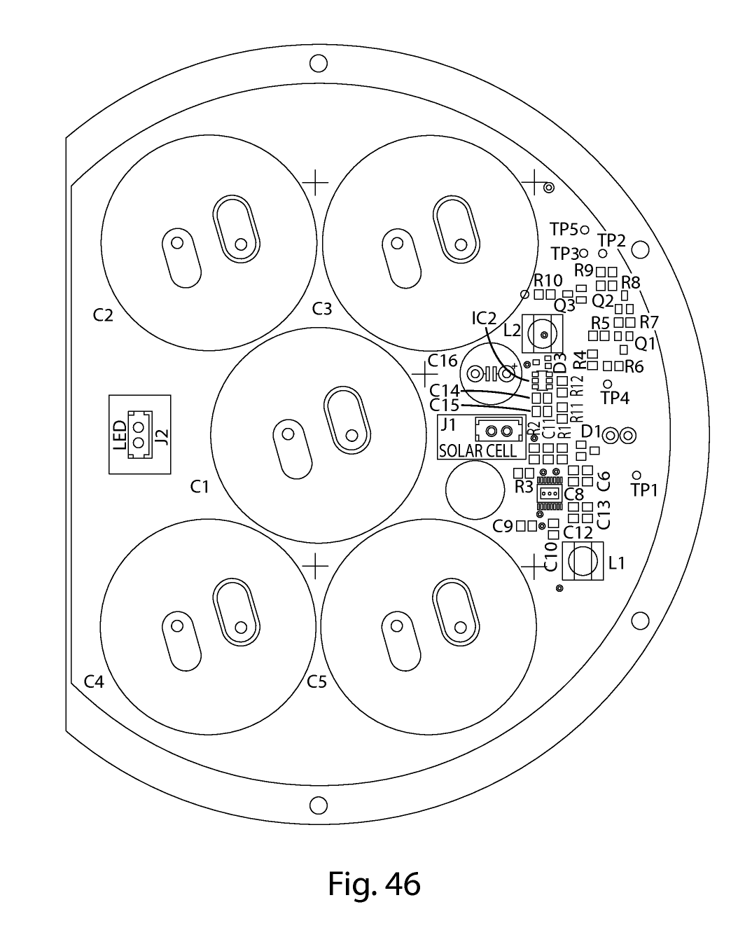

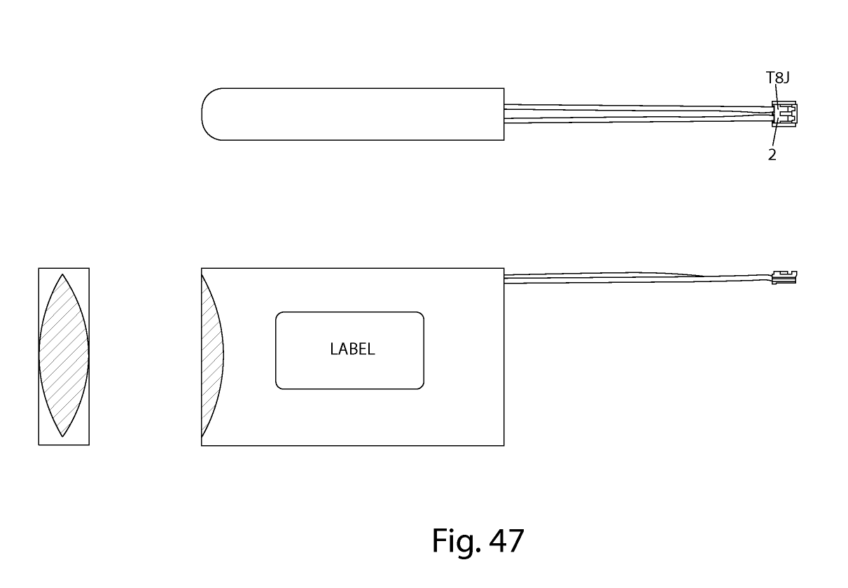

A circuit diagram illustrating one example of electronic circuitry that may be used with the above embodiments is shown in FIG. 43. One example of a battery configuration that may be used with the above embodiments is shown in FIG. 44. A bottom view of an example of a circuit board that may be used with the light sources in the above embodiments is illustrated in FIG. 45. A bottom view of another example of a circuit board that may be used with the above embodiments is illustrated in FIG. 46. An example of a battery that may be used with the above embodiments is shown in FIG. 47. Optionally, the battery may be a lithium-ion battery and may have the dimensions shown in FIG. 47 (the dimensions are approximate and are shown in inches). Further optionally, with a full charge, the battery may supply approximately 3.7 volts to the lighted memorial.

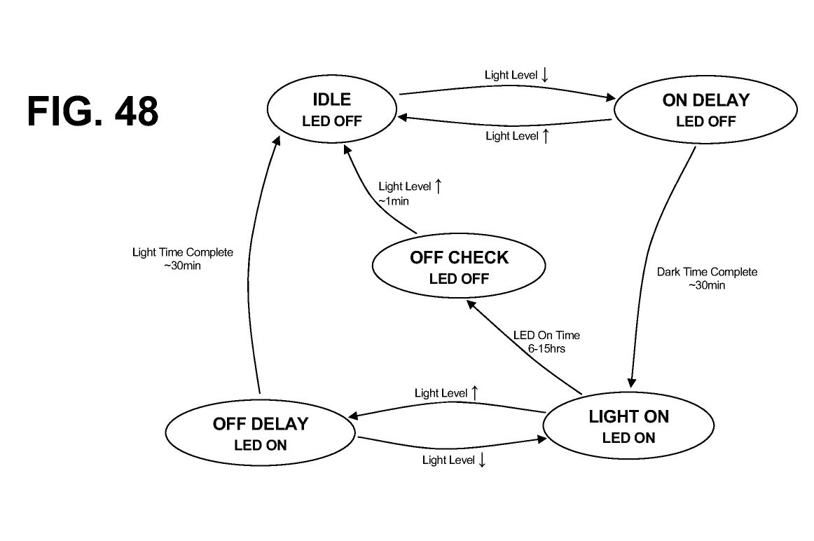

A flow chart showing one example of programmable logic that may be used in connection with activating and deactivating the light sources in the above embodiments is shown in FIG. 48. Beginning from the “LIGHT ON” status in which the light source is on, if the photosensor detects an environmental light level above a threshold value (for example, if the sun comes up), the status of the light source will change to “OFF DELAY,” which will keep the light source on for 30 minutes and then check whether the light level is still above the threshold value. If the light level is still above the threshold value at the end of the 30 minute delay, then the state of the light source will change to “IDLE,” and the light source will be turned off. However, if the light level is below the threshold value at the end of the 30 minute delay (for example, if the photocell was only momentarily exposed to light), then the status of the light source will change back to “LIGHT ON” and the light source will be kept on. From the “IDLE” status, if the photocell detects an environmental light level below a certain threshold (for example, if the sun goes down), then the status of the light source will change to “ON DELAY,” which will keep the light source off for 30 minutes and then check whether the light level is still below the threshold value. If the light level is still below the threshold value at the end of the 30 minute delay, then the status of the light source will change to “LIGHT ON” and the light source will be turned on. However, if the light level is above the threshold value at the end of the 30 minute delay (for example if the photocell was only momentarily covered), then the status of the light source will change back to “IDLE” and the light source will be kept off.

The delays may prevent the light source from turning on and off in response to only temporary light or temporary absence of light in the environment. Optionally, the delays may include sampling the environmental light level during the delay time in addition to or instead of sampling at the end of the delay time. For example, the light level may be detected five times during the delay. If any of those samples are above or below the applicable threshold, the status of the light source may be returned to its previous status.

The flow chart in FIG. 48 also includes an “OFF CHECK” as an additional double-check if the light source has been on for a certain length of time. Beginning at “LIGHT ON,” if the light source has been in the on state for between 6-15 hours, the state of the light source transitions to “OFF CHECK” and the light source is turned off. If the environmental light level is above a threshold value after a one minute delay, then the status of the light source will change to “IDLE” and the light source will be turned off. If the environmental light level is below the threshold value after the one minute delay, then the status of the light source will change back to “LIGHT ON” and the light source will be turned back on. This delay may also sample the environmental light level multiple times during the one minute delay, similar to the delays described above.

### XII. Virtual Memorial

Any of the above embodiments may be modified to include a code, website or other suitable communication system that may be used by visitors to access information regarding the deceased. Optionally, the code may be a Quick Response code that may be scanned by a smart phone to access information regarding the deceased. The code may be contained in the lens, or by any other suitable element of the lighted memorial. Further optionally, the lighted memorial may include a low power blue tooth communication system to communicate a website to a smart phone.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the” or “said,” is not to be construed as limiting the element to the singular.

1. A lighted memorial comprising:
a monument portion;
a base portion, at least one of the monument portion and the base portion defining at least one recess; and
at least one light source positioned at least partially within the at least one recess for illuminating at least a portion of the monument portion, the at least a portion of the monument portion including information regarding a deceased,
wherein the at least one recess is adapted to receive wiring for connecting between the at least one light source and a power source.

2. The lighted memorial of claim 1 wherein the at least one light source includes a casing, a light and a lens.

3. The lighted memorial of claim 2 wherein the casing includes a positive positioning device.

4. The lighted memorial of claim 3 wherein the casing includes an upper casing and a lower casing, the upper casing positioned at an angle relative to the lower casing.

5. The lighted memorial of claim 1 wherein the at least one light source is a light bar positioned adjacent a top face of the base portion.

6. The lighted memorial of claim 1 wherein the at least one light source illuminates the at least a portion of the monument portion from a position above the at least a portion of the monument portion.

7. The lighted memorial of claim 6 wherein the at least one light source is a curved light bar.

8. The lighted memorial of claim 6 wherein the at least one light source includes an elongate bar with a straight portion and a curved portion.

9. A lighted memorial comprising:
a housing;
a lens secured relative to the housing, at least a portion of the lens being at least one of generally transparent and translucent, the lens including information regarding a deceased;
a light source positioned below the lens, the light source illuminating at least a portion of the lens;
a power storage device connected to the light source, the power storage device configured to supply power to the light source; and
a solar panel connected to the power storage device and positioned below the lens, the solar panel configured to transmit power to the power storage device.

10. The lighted memorial of claim 9 including a ramped surface oriented at an angle relative to the lens, the ramped surface positioned below the lens,
wherein the light source is secured to the ramped surface, the ramped surface positioning the light source at a desired angle.

11. The lighted memorial of claim 9 wherein the housing is adapted to be positioned adjacent a base portion and a monument portion.

12. The lighted memorial of claim 11 wherein an anchor assembly is connected to the housing, the anchor assembly including an anchor bar attached to the housing, the anchor bar having a bend for positioning within a rigid material.

13. The lighted memorial of claim 9 wherein the housing is capable of being mounted within a base portion.

14. The lighted memorial of claim 13 including a snap fastener configured to engage the base portion.

15. A lighted memorial comprising:
a base portion, the base portion adapted to receive cremated remains of a deceased;
a lens secured relative to the base portion, at least a portion of the lens being at least one of generally transparent and translucent, the lens including information regarding the deceased; and
a light source illuminating at least a portion of the lens.

16. The lighted memorial of claim 15 including a housing, the housing including a light housing for supporting the light source and a remains housing for containing the cremated remains of the deceased,
wherein the lens is secured relative to the housing,
wherein the base portion defines a recess, the housing positioned at least partially within the recess.

17. The lighted memorial of claim 16 including at least two light sources, a first light source positioned adjacent a first side of the lens and a second light source positioned adjacent a second side of the lens.

18. The lighted memorial of claim 17 wherein the first light source and the second light source are generally facing each other.

19. The lighted memorial of claim 17 wherein the first light source and the second light source are generally facing away from each other.

20. The lighted memorial of claim 17 wherein the light housing includes a flange, the flange engaging a top surface of the base portion to positively locate the housing within the recess.
